(19) United States
(12) Patent Application Publication
(10) Pub. No.: US 2001/0054013 A1
(43) Pub. Date: Dec. 20, 2001

(54) Method for selling goods in the internet electronic commerce business

(76) Inventor: Kyeung Hun Song, Seoul (KR)

Correspondence Address: HARNESS, DICKEY & PIERCE, PLC, P.O. BOX 828, BLOOMFIELD HILLS, MI, 48303, US

(21) Appl. No.: 09/881,434

(22) Filed: Jun. 14, 2001

(30) Foreign Application Priority Data
Jun. 17, 2000 (KR) 2000-33480
Jun. 17, 2000 (KR) 2000-33481

(51) Int. Cl. G06F 17/60

(52) U.S. Cl. 705/26

(57) ABSTRACT

1. Technical field the invention disclosed in claims pertains to

The present invention relates to a method for operating databases in an electronic commerce business system and a computer-readable recording medium of storing programs for realizing the method.

2. Technical subject the invention tends to solve

The present invention provides a goods sale method in the internet electronic commerce business of performing goods sales in types customers wish by individually and systematically managing databases of various goods, and a computer-readable recording medium of storing programs for realizing the method.

3. Gist in a solution method of the invention

The present invention comprises steps of (1) building an option-type goods database for option-type goods saleable in option; (2) building an option items database for respective constituents consisting of the respective option-type goods; (3) building an option items classification database for options substantially saleable as to the respective option items; and (4) providing information on the respective databases to users who connect to a service-providing server through a network, and completing deals in option-type goods by considering respective options selected by the users.

4. Important use of the invention

The present invention is used for the internet electronic commerce business and the like.

### BACKGROUND OF THE INVENTION

1. Field of the Invention

The present invention relates to a method for administering database in an electronic commerce business system and a computer-readable recording medium of storing programs for realizing the above method.

2. Reference to Related Patents Applications

U.S. Pat. No. 5,666,493 System for managing customer orders and method of implementation

U.S. Pat. No. 5,715,314 Network sales system

U.S. Pat. No. 5,745,681 Stateless shopping cart for the web

U.S. Pat. No. 5,819,285 Apparatus for capturing, storing and processing co-marketing information associated with a user of an on-line computer service using the world-wide-web

U.S. Pat. No. 6,029,141 Internet-based customer referral system

U.S. Pat. No. 6,115,690 Integrated business-to-business Web commerce and business automation system

3. Description of Related Art

Goods people purchase can be not only in finished product forms, but in the forms of adding options based on their own selections or in the bundle forms combining various goods.

However, in the existing internet electronic commerce business, a problem occurs in that there exists a limitation in buyers' purchasing goods through the internet electronic commerce business since a commerce business form is not provided that reflects buyers' opinions as in option-type goods or bundle-type goods.

First, a description will be described in detail on the problem that option-type goods purchases have in the internet electronic commerce business.

A method that enables a user to select various options for purchasing one product is one that is generally used in the off-line. That is, in case of buying a pair of shoes, a user can buy them by selecting their size, color, material, and the like according to his taste even though the shoes have the same trademark and shape.

Further, when adding one option, some cases have no influence on their overall prices as in shoes, but other cases have influences on their overall prices Even in the case that a price of a product itself fluctuate based on additional options, a separated compromise on the price can be made for the price after purchasing the product fit to one's taste.

That is, in case of purchasing a desk, the number of drawers, the size of a bookstand, and so on, can be provided as one option in purchasing the desk. In such a case, a desk price can fluctuate based on the kinds of options, and the deal for the desk can be made based on the fluctuated price.

However, in the internet electronic commerce business being actively used, there does not exist a function of enabling individual options as in the off-line. Further, there exists a problem in that it requires a complicated process in operating services to sell a product in different prices based on its options.

That is, in the existing electronic commerce business, options to a product are processed in hard-coding by recognizing the product as an object, so there exists a problem in that editing is difficult and selections of optional goods are limited.

Further, there occurs a problem in that, in the electronic commerce business, price policies to options are not freely used. For example, in case that option prices are applied based on the quantity of goods, since the cases the prices go up and the cases the prices remain unchanged, based on the kinds of options, are distinguishingly applied, there exists a problem in that a separate management system exists in service operations.

Next, a description will be described in detail about a problem existing in bundle-type goods purchases in the internet electronic commerce business, as follows.

The way of selling various combinable goods in a bundle is one generally used on the off-line. That is, examples for bundling goods may be a washing gadget set(toothpaste, toothbrush, soap, razor), computer-related components(CPU, hard drive, main board), and so on.

However, in the internet electronic commerce business being actively used, there exists a problem in that it is impossible to sell bundle goods by recognizing it as one object. That is, in the existing electronic commerce business, applying a hard-cording method to homepages causes inconvenient editing as well as limits the selections of bundle goods.

Further, even in a bundle sale method in the off-line, since consumers can not freely select articles in bundle goods, a problem occurs in that inconvenience is caused that the consumers have to buy the bundle goods together with articles involved in the bundle goods which the consumers do not use in selecting the goods.

### SUMMARY OF THE INVENTION

The present invention has been advised to solve the problem as stated above, it is an object of the present invention to provide a goods sale method in the internet electronic commerce business for performing goods sales as a form customers desire by individually and organically managing a database of various goods and a computer-readable recording medium of storing programs for realizing the method.

Further, it is an object of the present invention to provide an option-type goods sale method in the internet electronic commerce business and a computer-readable recording medium of storing programs for realizing the method, in order for customers themselves to directly select and purchase they desire out of diverse options on one goods by managing diverse goods options by individual databases.

Furthermore, it is an object of the present invention to provide a bundle-type goods sale method in the internet electronic commerce business and a computer-readable recording medium of storing programs for realizing the method, capable of selling respective goods customers desire in bundle by individually and organically managing various goods databases.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing a structure of an electronic commerce business system according to an embodiment of the present invention;

FIGS. 2a to 2d are views for showing structures of databases used for an option-type goods sale method in the internet electronic commerce business according to an embodiment of the present invention;

FIGS. 3a to 3d are views for showing structures of databases used for a bundle-type goods sale method in the internet electronic commerce business according to an embodiment of the present invention;

FIG. 4 is a flow chart for the option-type goods sale method in the internet electronic commerce business according to an embodiment of the present invention; and

FIG. 5 is a flow chart for the bundle-type goods sale method in the internet electronic commerce business according to an embodiment of the present invention.

### DETAILED DESCRIPTION OF THE PREFERRED EMBODIMENT

In order to achieve the above objects, a method according to the present invention, in a goods sale method in the internet electronic commerce business applied to an electronic commerce business system, comprises steps of (1) building an option-type goods database for optionally saleable option-type goods; (2) building option items databases for respective option components constituting the option-type goods; (3) building an option items classification database for substantially saleable options with respect to respective option items; and (4) providing information on the respective databases to users connected to a service-providing server through a network and completing deals in option-type goods by considering respective options selected by the users.

Further, another method according to the present invention, in a goods sale method in the internet electronic commerce business applied to an electronic commerce business system, comprises steps of (1) building a bundle-type goods database on bundle-type goods saleable in bundle; (2) building a bundle items database on respective constituents constructing the bundle-type goods; (3) building a by-bundle-items goods database on substantially saleable goods with respect to the respective bundle items; and (4) providing information on the respective database to users connected to a service-providing server through a network and completing deals en bloc in bundle-type goods with respect to goods of the respective constituents selected by the users.

Furthermore, the present invention, in order to sell goods in the internet electronic commerce business, in an electronic commerce business system having a large capacity processor, comprises functions of (1) building an option-type goods database for optionally saleable option-type goods; (2) building an option items database on respective option components constituting the respective option-type goods; (3) building an option items classification database for substantially saleable options with respect to the respective option items; and (4) providing information on the respective databases to users connected to a service-providing server through a network and completing deals in option-type goods by considering respective options selected by the users.

Further, the present invention, in an electronic commerce business system having a large capacity processor in order to sell goods in the internet electronic commerce business, provides a computer-readable recording medium of storing programs for realizing functions of (1) building a bundle-type goods database on bundle-type goods saleable in bundle; (2) building a bundle items database on respective constituents constructing the bundle-type goods; (3) building a by-bundle-items goods database on substantially saleable goods with respect to the respective bundle items; and (4) providing information on the respective databases to users connected to a service-providing server through a network and completing deals en bloc in bundle-type goods with respect to goods of respective constituents selected by the users.

There are selectable items when purchasing goods. For example, in case of clothes, the selectable items may be sizes, colors, and so on, and, in case of wrapping, quality wrappers, regular wrappers, and so on.

There is one additional item in this option structure, which is prices based on the options. The prices can be classified into two parts, one of which is the part incurring costs, and the other is the part not incurring costs.

Again, there are two portions in the part incurring the costs, one of which is the portion of increasing an option price based on the increase of the quantity of goods, and the other is the portion of fixing the option price regardless of the quantity of goods.

That is, an administrator can freely use the option policy of goods by reflecting the option policy as stated above on the database.

Further, the present invention, in order to sell bundle goods in the electronic commerce business, manages respective goods saleable in bundle by individual databases while enabling the respective databases to have systematical relations, so that users can purchase goods in bundle they wish.

It is assets and services to be sold in the internet electronic commerce business, and it would be goods to be displayed most out of the assets. That is, the unit of goods being sold in the electronic commerce business is the most basic contents, a basic element in display, and an important factor for settlements.

In real world, a method of selling goods in bundle is well used. Examples for bundling goods may be found in a washroom set(toothpaste, toothbrush, soap, razor), computer components (CPU, hard disc drives, main boards), and so on.

It can satisfy sales maximization, consumers' convenience, and economical aspects to automatically apply the examples to goods displayed in the electronic commerce business. That is, the work of administrators can be reduced by automatically processing the bundling of goods, and users who purchase goods can select goods they desire by recognizing bundled goods themselves in one merchandise.

As stated above, the present invention provides diversity, rather than standardization, in adding options or bundling goods based on buyers' requirements by managing goods information used in the internet electronic commerce business through databases.

The above objects, features, and advantages will be more apparent through a following detailed description with reference to the attached drawings. Hereinafter, a preferred embodiment of the present invention will be described in detail with reference to the attached drawings.

The present invention can present a concrete embodiment in forms of bundle-type goods sales and option-type goods sales as stated above, which will be respectively described.

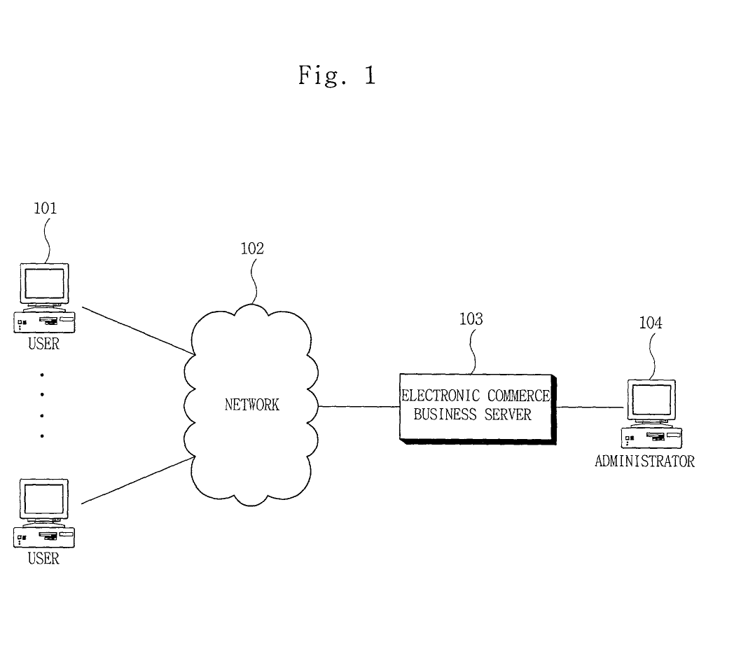

FIG. 1 is a view for showing a structure of an electronic commerce business system according to an embodiment of the present invention.

An administrator 104 systematically classifies respective goods and options for the respective goods in an electronic commerce business server 103 in order to enable option-type goods and bundle-type goods to be sold and then builds a database.

A user 101 who wish to purchase the option-type goods uses a network 102 such as the internet the like, connects to the electronic commerce business server 103, and selects option-type goods he or she wants. Thereafter, the user 101 can select only options he or she wants from options provided through an option-type goods guide and buy goods in a group.

Further, the user 101 who wishes to buy bundle-type goods can purchase goods en bloc by bundling goods he or she wants from individual goods provided through a bundle-type goods guide after selecting bundle-type goods he or she wishes by using the network 102 such as the internet and the like to connect to the electronic commerce business server 103.

That is, options can or can not be selected based on the selections of the user 101 for the option-type goods or bundle-type goods, goods can or can not be requested for purchases in a bundle-type. The present invention gives users rights to deciding goods purchase types to the utmost.

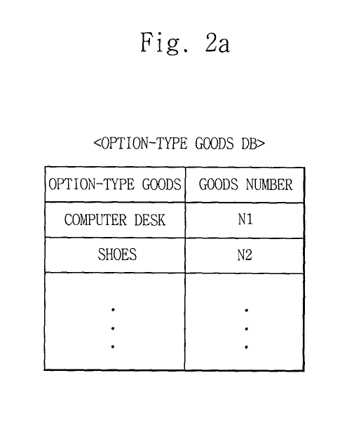

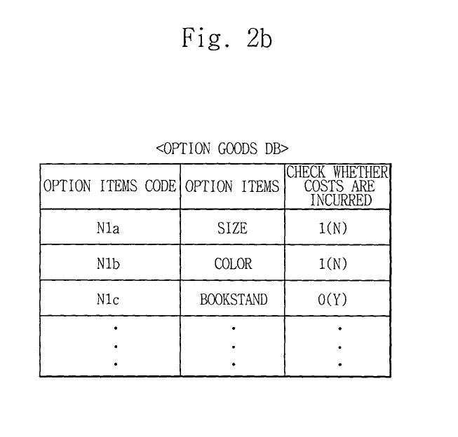

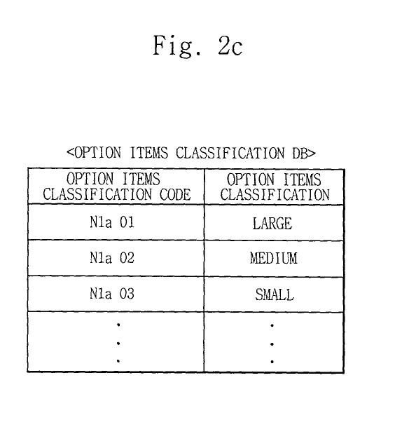

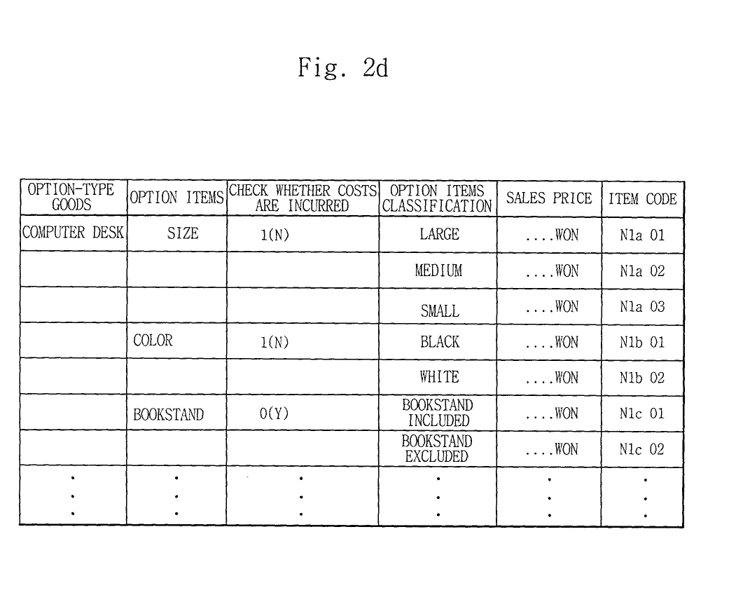

FIG. 2a to 2d are views for showing structures of databases used for an option-type goods sale method in the internet electronic commerce business according to an embodiment of the present invention.

FIG. 2a is a view for showing a database built for option-type goods saleable in options. A computer desk is classified as an option-type goods so that a user can purchase the computer desk by selecting only options the user wants. Further, in case of shoes having the same trademark, the shoes are classified as an option-type goods so that a user can purchase them by selecting options the user wish out of various options (sizes, colors, materials). In addition, a database will be built for all goods having options.

Next, FIG. 2b is a view for showing a database on option items. In the option-type database as shown in FIG. 2a, a computer desk is picked up as an example. In case of the computer desk, there are selection items, that is, options such as sizes, colors, presence/absence of a bookstand, and so on. Accordingly, a database is built as to option items necessary in case that users wish to buy a computer desk so that the users can use the database.

At this time, the kinds of the options can be divided into a selection type and an input type, and then into two parts based on whether or not costs are incurred. Further, the part in which the costs are incurred can be classified into two cases based on whether or not quantity is reflected to the costs. Accordingly, in building an option items database, a separate field with respect to information stated above, for example, an item as to whether or not cost options occur, is made and managed.

Next, FIG. 2c is a view for showing a database built for option item classifications. In the database on option items shown in FIG. 2b, sizes are picked up as an example for a description. The types of sizes are classified into large, medium, and small, the database is built with respect to options that can be substantially classified as to one goods. That is, in option-type goods, the database is for goods options that users can finally select.

Likewise, as for the colors and bookstands, an administrator builds a database for a list of options he or she can provide. That is, in case of the colors, the database can show what colors can be concretely provided and, in case of the bookstand, which bookstand with how many compartments can be provided.

Next, FIG. 2d is a view for showing a result displayed on a screen in case that a user connects to the electronic commerce business 103. That is, an administrator 104 builds the databases as stated above for constructing a display shown in FIG. 2d.

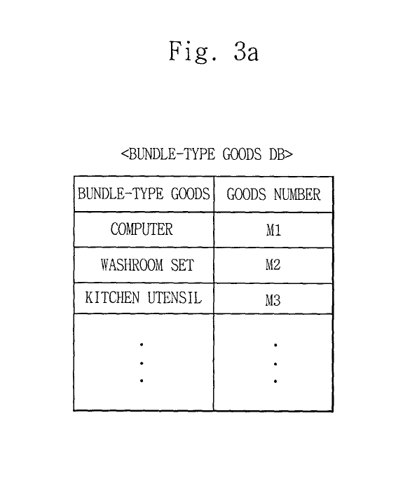

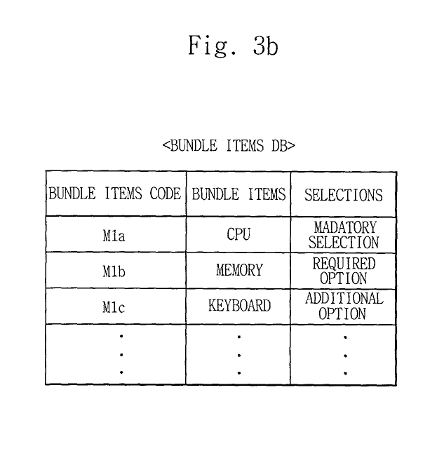

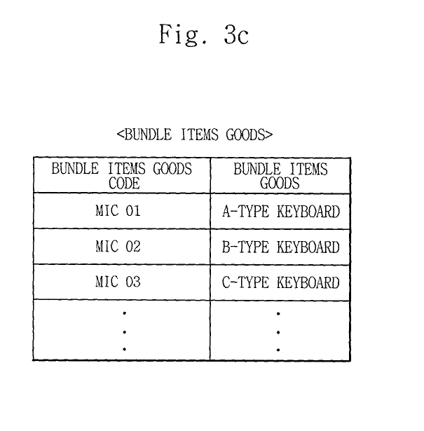

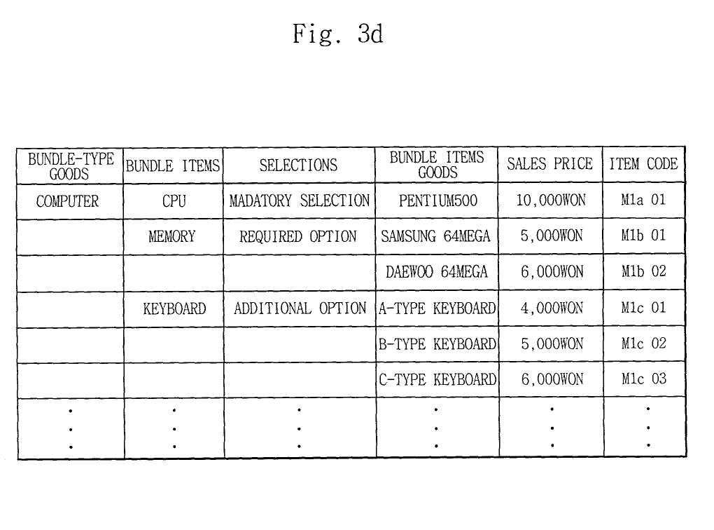

FIG. 3a to FIG. 3d are views for showing structures of databases used for a bundle-type goods sale method in the internet electronic commerce business according to an embodiment of the present invention.

FIG. 3a is a view for showing a database built for bundle-type goods saleable in bundle. That is, a computer is classified as a bundle-type goods so that a user can select only specifications he or she wants and then assemble the computer. Further, a washroom set is also classified as a bundle-type goods so that the user can purchase only necessary tools from various kinds of washroom tools. In addition to them, all goods saleable in bundle are built in a database.

Next, FIG. 3b is a view for showing a database built for bundle items.

A description will be made with an example of a computer in the bundle-type goods database shown in FIG. 3a.

A computer requires lots of components such as a central processing unit (CPU), memories, a keyboard, and so on. Accordingly, by building a database as to bundle items necessary in case that users wish to assemble a computer, the users can assemble a computer by selecting purchase items through the use of the database.

However, the bundle items such as the CPU, memories, keyboard, and the like can not be purchased within bundle-type goods of a computer, but provided as individual lists, so that users can purchase anytime.

In the components of a computer, the component such as the CPU should be installed, but components such as keyboard and the like, which have been already purchased, can be continuously used. Therefore, by preparing a check field in a database, the users can determine whether each of bundle items is a required item or an optional item. Further, as for respective components, it should be obviously known whether there are respective items that an administrator can provide with respect to the respective items. To do so, a check field is defined as follows.

That is, the bundle items may be defined as four kinds of options such as mandatory selection, required option, additional option, and alternative option.

The mandatory selection means a selection that should be made from bundle items. For example, products which must be unconditionally selected, like a CPU which is a product indispensable in a computer, are applicable.

The required option is made to select products, like a disc drive, which must be selected but can be selected by user in their kinds since the purchase can be made by kind.

The additional option is made to select products which may be additionally selected, which is applicable to the products which may or may not be selected.

The alternative option is made to select only necessary products out of plural products or all the products.

Next, FIG. 3c is a view for showing a database built for by-bundle-items goods.

FIG. 3c is a view for showing keyboards, for example, in the bundle items database shown in FIG. 3b. Since there may be various kinds of keyboards such as A-type, B-type, C-type, and so on, in the kinds of keyboards, a database is built for such goods, which is, that is, a database for a list of goods a user finally wish to purchase in the bundle-type goods.

Likewise, as for CPUs and memories, an administrator builds a database on a list of goods he or she can provide.

Next, FIG. 3d is a view for showing a result displayed on a screen in case that a user selects bundle-type goods by connecting to the electronic commerce business 103. That is, for a structure shown in FIG. 3d, the administrator 104 builds the databases stated above.

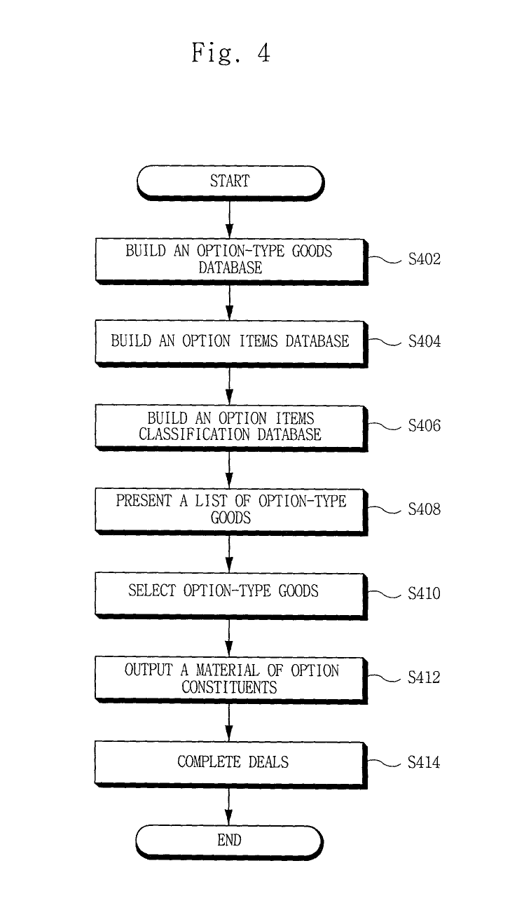

FIG. 4 is a flow chart for the option-type goods sale method in the internet electronic commerce business according to an embodiment of the present invention.

An administrator builds a database for option sales in the electronic commerce business server 103.

First, a database of option-type goods as shown in FIG. 2a is built (S402). The database for option-type goods refers to a list of goods saleable in option.

Next, an option items database as shown in FIG. 2b is built (S404). The option items database refers to a list of respective option constituents consisting of option-type goods. At this time, it may be described whether costs are incurred according to the respective option constituents (refer to the description on FIG. 2b) Such costs become referred in a stage of completing goods deals.

Next, an option items classification database as shown in FIG. 2c is built (S406). The option items classification database refers to a list options substantially saleable with respect to the respective option constituents of FIG. 2b, which refers, that is, to concrete options of goods a user purchases.

If the database is built, the administrator 104 drives a program in the electronic commerce business server 103, and present a list of option-type goods at homepages by using the databases built in the server 103 (S408).

The user 101 connects to the electronic commerce business server 103 the administrator 104 operates by using the network 102 such as the internet and the like, and selects option-type goods he or she wishes out of the list of option-type goods (S410).

If the user 101 selects one option-type goods from the list of option-type goods, the electronic commerce business server 103 reads in, for outputs, a material of all option constituents a user can purchase as to the option-type goods selected as shown in FIG. 2d from the database in the electronic commerce business server 103 (S412).

The user 101 may select options of goods he or she wants for purchase after looking at the outputted list (S414).

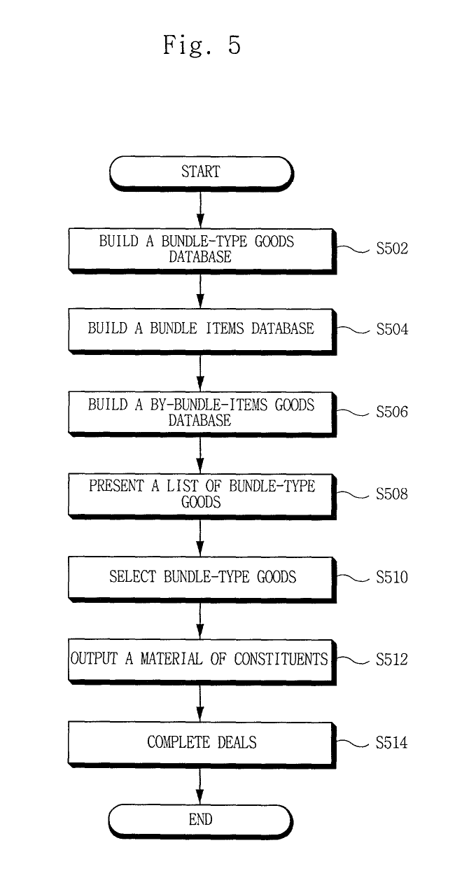

FIG. 5 is a flow chart for the bundle-type goods sale method in the internet electronic commerce business according to an embodiment of the present invention.

The administrator builds a database for bundle sales in the electronic commerce business server 103.

First, a database of bundle-type goods as shown in FIG. 3a is built (S502) . The database of bundle-type goods refers to a list of goods saleable in bundle.

Next, a bundle items database as shown in FIG. 3b is built (S504). The bundle items database refers to a list of respective constituents consisting of bundle-type goods. At this time, classification are made into a mandatory selection, required option, additional option, and so on according to characteristics of the respective constituents (refer to the description of FIG. 3b).

Next, a by-bundle-items goods database as shown in FIG. 3c is built (S506) The by-bundle-items goods database refers to a list of goods substantially saleable with respect to the respective constituents of FIG. 3b, which refers, that is, to a concrete list of goods a user purchases.

If the database is built, the administrator 104 drives a program in the electronic commerce business server 103, and presents the list of bundle-type goods at homepages by using the database built in the server 103 (S508).

The user 101 connects to the electronic commerce business server 103 by using the network 102 such as the internet and the like, and selects bundle-type goods he or she wants out of the list of bundle-type goods the electronic commerce business server 103 provides (S510).

If the user 101 selects one bundle-type goods from the bundle-type goods, the electronic commerce business server 103 reads in, for outputs, a material of all constituents the user can purchase with respect to the bundle-type goods selected as shown in FIG. 3d from the databases in the electronic commerce business server 103 (S512).

The user 101 can purchase only goods he or she wants through selections after looking at the list outputted (S514).

As stated above, the present invention has an excellent effect in that more diverse services can be provided to users by systematically managing options as to respective goods.

Further, the present invention has an excellent effect in that administrators can reduce their work by automatically processing the goods management.

Further, the present invention has an excellent effect in that administrators can manage materials as to diverse options without a complex process as well as the administrators can freely choose, add, and delete option policies.

Further, the present invention has an excellent effect in that users who purchase goods are satisfied with prices and functions of the goods since a goods bundle itself is recognized as one goods and the users can select and purchase only goods he or she wants en bloc.

Further, the present invention has an excellent effect in that users can purchase bundle-type goods except goods unwanted, compared to off-line purchase methods in which the users have to purchase unnecessary goods because of desired goods even though there are the unnecessary goods in a bundle.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A goods sale method in the internet electronic commerce business applied to an electronic commerce business system, comprising steps of:
(1-1) building an option-type goods database for option-type goods saleable in option;
(1-2) building an option items database for respective constituents consisting of the respective option-type goods;
(1-3) building an option items classification database for options substantially saleable as to the respective option items; and
(1-4) providing information on the respective databases to users who connect to a service-providing server through a network, and completing deals in option-type goods by considering respective options selected by the users.

2. The goods sale method as claimed in claim 1, wherein the step (1-4) includes steps of:
(1-5) presenting a list of option-type goods by using the option-type goods database to the users who have connected to the service-providing server through the network;
(1-6) providing a material of all options purchasable by using the option items database and the option items classification database for option-type goods selected by the users from the list of option-type goods; and
(1-7) completing the deals of option-type goods by combining the options selected by the users from options.

3. The goods sale method as claimed in claim 1, wherein the option items database in step (1-2) includes a check field of notifying of what limited terms there are in selecting the respective option constituents.

4. The goods sale method as claimed in claim 2, wherein the option items database in step (1-2) includes a check field of notifying of what limited terms there are in selecting the respective option constituents.

5. A goods sale method in the internet electronic commerce business applied to an electronic commerce business system, comprising steps of:
(5-1) building a bundle-type goods database for bundle-type goods saleable in bundle;
(5-2) building a bundle items database for respective constituents consisting of the respective bundle-type goods;
(5-3) building a by-bundle-items goods database for goods substantially saleable as to respective bundle items; and
(5-4) providing information of the respective database to users who connect to a service-providing server through a network, and completing deals en bloc in bundle-type goods as to goods of the respective constituents selected by the users.

6. The goods sale method as claimed in claim 5, wherein the step (5-4) includes steps of:
(5-5) presenting a list of bundle-type goods by using the bundle-type goods database to the users who have connected to the service-providing server through the network;
(5-6) providing a material of all goods purchasable by using the bundle items database and the by-bundle-items goods database as to bundle-type goods selected by the users from the list of bundle-type goods; and
(5-7) completing deals en bloc in bundle goods for the goods selected by the users from the goods.

7. The goods sale method as claimed in claim 4, wherein the bundle items database in step(5-2) includes a check field of notifying of what limited terms there are in selecting the respective constituents.

8. The goods sale method as claimed in claim 5, wherein the bundle items database in step (5-2) includes a check field of notifying of what limited terms there are in selecting the respective constituents.

9. A computer-readable recording medium of storing programs for realizing functions of:
(9-1) building an option-type goods database for option-type goods saleable in option;
(9-2) building an option items database for respective constituents consisting of the respective option-type goods;
(9-3) building an option items classification database for options substantially saleable as to the respective option items; and
(9-4) providing information on the respective databases to users who connect to a service-providing server through a network, and completing deals in option-type goods by considering respective options selected by the users.

10. A computer-readable recording medium of storing programs, in an electronic commerce business system having a large capacity processor in order to sell goods in the internet electronic commerce business, for realizing functions of:
(10-1) building a bundle-type goods database for bundle-type goods saleable in bundle;
(10-2) building a bundle items database for respective constituents consisting of the respective bundle-type goods;
(10-3) building a by-bundle-items goods database for goods substantially saleable as to respective bundle items; and
(10-4) providing information of the respective database to users who connect to a service-providing server through a network, and completing deals en bloc in bundle-type goods as to goods of the respective constituents selected by the users.
